(19) United States
(12) Patent Application Publication
(10) Pub. No.: US 2016/0003115 A1
(43) Pub. Date: Jan. 7, 2016

(54) Filter Medium, Filter Element with a Filter Medium, Filter System, and Method for Producing a Filter Medium

(71) Applicant: MANN+HUMMEL GMBH, Ludwigsburg (DE)

(72) Inventor: Florentin van Uffelen, Ludwigsburg (DE)

(21) Appl. No.: 14/751,972

(22) Filed: Jun. 26, 2015

(30) Foreign Application Priority Data
Jul. 2, 2014 (DE) 10 2014 009 707.2

(51) Int. Cl. F01M 11/03; B01D 35/00; B01D 29/56; B01D 29/00; B01D 29/07

(52) U.S. Cl. CPC F01M 11/03; B01D 29/0093; B01D 29/07; B01D 29/56; B01D 35/005

(57) ABSTRACT

The invention relates to a filter medium (10) for the filtration of a fluid in an intended throughflow direction (16) from an inlet side (30) to an outlet side (32), which has at least one first medium layer (12) and at least one second, planar medium layer (14) as a support and drainage layer. The second medium layer (14) is arranged downstream of the first medium layer (12) in the throughflow direction (16). A retention capacity of the second medium layer (14) as a whole with respect to particles in the fluid that passes through the first medium layer (16) is less than the retention capacity in the first medium layer (12).The invention further relates to a filter element (50), which includes such a filter medium (10) as well as a method for producing such a filter medium (10).

### TECHNICAL FIELD

The invention relates to a filter medium for the filtration of fluids, in particular for the filtration of liquids such as oil, for example, as well as a filter element with such a filter medium and a filter system, in particular for use as an oil filter of an internal combustion engine, and a method for producing such a filter medium.

### BACKGROUND

Multilayer filter media for the filtration of fluids are known. The use of filter layers with different properties effects a division of the tasks to be carried out by the filter media. In this way the filter medium can be optimized with respect to its filter capacity, the pressure loss that is produced, and its field of use.

From DE 199 22 326 A1, a filter medium is known that has at least two filter layers, wherein the one is provided for preseparation and the second for absolute filtration. Between these two filter layers is the support layer, which preferably is made of a largely cellulose-containing filter paper. The filter fineness of the support layer is in every case less than the main separation layer, which is on the clean side of the support layer. The chief task of the support layer is to provide sufficient stability to the filter medium during processing for filter use. At the same time the processing properties of the filter medium are improved by provision of a support layer made of filter paper. This can be further processed by methods known for filter paper.

EP 1366791 B1 describes a filter medium that consists of a support layer and a fiber layer which is permanently applied to a support layer. The fiber layer comprises electrostatically spun polymer fibers that are cross-linked with one another. The support layer is impregnated and stiffened.

### SUMMARY OF THE INVENTION

The object of the invention is to create a filter medium which, with a mechanically stable design, has a favorable flow behavior of the filtered fluid.

A further object of the invention is to create a filter element with such a filter medium as well as a filter system which, with a mechanically stable design, has a favorable flow behavior of the filtered fluid.

A further object of the invention is to create a method of economically producing such a filter medium which, with a mechanically stable design, has a favorable flow behavior of the filtered fluid.

The aforementioned objects are accomplished according to one aspect of the invention with a filter medium for the filtration of a fluid that comprises at least one first medium layer and at least one second planar medium layer as a support and drainage layer.

Favorable embodiments and advantages of the invention can be seen from the further claims, the description, and the drawing.

A filter medium is proposed for the filtration of a fluid in an intended throughflow device from an inlet side to an outlet side, which comprises at least one first medium layer and at least one second planar medium layer which covers the first medium layer as a support and drainage layer. Here the second medium layer is arranged downstream of the first medium layer in the throughflow direction. Further, a retention capacity of the second medium layer as a whole with respect to particles in the fluid that passes through the first medium layer is less than the retention capacity in the first medium layer.

A filter medium that is used, for example, for primary and secondary oil flow filtration for filtration in hydraulic and gear oil applications frequently has a fiber layer in a first medium layer for filtration of the fluid. Since the fiber layer, which can comprise glass fibers as well as synthetic fibers, for example PET based, is less mechanically stable, favorably a support layer is used in the form of a second medium layer as a mechanical carrier of the filter medium. Here, the actual filter layer is preferably mounted directly on the support layer. To assist the filtration effect, good drainage of the fluid after passing through the filter layer is favorable. This support layer requires no filter properties for the particles that are already to be filtered out by the first medium layer. However, it is favorable when a fiber layer is used as the first medium layer, in which fibers can be extracted from the layer, to retain these fibers so that they cannot damage assemblies arranged on the downstream side such as internal combustion machines or gears, or cause increased wear of components.

The filter medium according to the invention advantageously has a combination of such a support and drainage layer as the second medium layer downstream of the first medium layer, which can also filter out and retain such fibers from the filtered fluid. In doing so, this support and drainage layer can be configured as an open-pored filter medium or also with a perforation and/or an additional structure in order to intensify the drainage effect. The structure of the second medium layer can be implemented by the production process of the filter medium (deposition) or subsequently by molding (pleating) and/or by pressing or also in a perforation step. Cut-off (separated) regions can be applied in an overlapping manner on other regions, so that a structure is produced.

In a design without perforations, i.e. here as a closed second medium layer, use as a support and drainage layer and retention layer for fiber media is favorable and suitable.

The first medium layer, in particular in the embodiment as a fiber layer, has thicknesses of from 0.5 mm to 1 mm for example, while the second medium layer as a support and drainage layer has a thickness of 0.5 mm for example.

The filter medium according to the invention has a planar second medium layer as a support and drainage layer, which in its lateral extent lies on the first medium layer, and thus differs significantly from embodiments according to the prior art, where, for example, adhesive beads are placed on the first medium layer and serve as stiffening and spacers between the folded filter media. These adhesive beads according to the prior art are substantially in strip form. Other embodiments according to the prior art have extruded plastic grids. Here again the approach according to the invention stands out in comparison as being substantially more flexible, easy, and economical in production. By means of suitable structuring of the second medium layer, further optimizations with respect to the supporting effect and drainage action may be favorably achieved.

In an advantageous embodiment, the second medium layer can comprise a fiber medium, preferably cellulose. The fiber medium can form the second medium layer throughout. Alternatively, the fiber medium can be provided in areas of the second medium layer. Such a support and drainage layer on the basis of cellulose instead of a conventional PBT or metal grid is very expedient, since, with fiber media as the first medium layer, there is a risk that fibers will escape and may enter the oil circulation system, which can lead to damage to an internal combustion engine. In addition, fiber media require a support and drainage layer. Both objects can be economically achieved by combining the fiber layer with a downstream cellulose layer (or mixed fiber layer), which can simultaneously serve as a support and retention layer for the washed-out fibers. Thus, in comparison with the prior art, cellulose has a marked cost advantage.

In addition, in contrast to plastic (PBT grids), cellulose does not soften when exposed to temperatures which can reach 150° C. when using an irternal combustion engine. The advantage lies in the mechanical stability of the filter medium, as the structure of the filter medium is preserved when exposed to temperatures. Here, the cellulose layer (or mixed fiber layer) can be designed in a pleated pattern in order to improve the drainage effect. There is no contamination of the oil circulation system by fibers, as these are retained by the cellulose layer. This enables fiber media to be used as the main flow oil filter, as a result of which markedly improved filtration performance in comparison with other filter media that are used is possible.

In a further favorable embodiment, the second medium layer can additionally or alternatively comprise a plastic film. The plastic film can have suitable passages or channels or can be interrupted in places. The plastic film can form the second medium layer throughout. Alternatively, the plastic film can be used with a fiber medium as a second medium layer. Here the plastic film can serve to stiffen the fiber medium and in addition reinforce the drainage effect. In a further alternative, the plastic film can be provided in areas in the second medium layer. Here again it is possible to design the second medium layer as a support and drainage layer. By suitable molding, a plastic film can be stiffened so that it can support the first medium layer. Further, a drainage effect is also possible as a result of the shape of the film. The retention effect with respect to fibers can be supported by suitable flow control of the filtered fluid, for example by guiding the filtered fluid into a region of a fiber medium that has an especially high retention effect for fibers. Preferably, this effect can be more favorably pronounced with cellulose or similar fibrous media. The use of a fleece which is mechanically stiffer than a fiber layer and can retain fibers if the pore size is suitable is also conceivable at this point.

Advantageously, therefore, the second medium layer can have perforations in the throughflow direction. These perforations can be regularly formed in the shape of circles, triangles, or rectangles; however, they also have irregular forms. The perforations can be designed as larger pores, for example larger than an average pore width of the first medium layer, or also holes. The average diameter can be between one and several millimeters for example. An elevation of the material in the form of a 3D structure, which can result from the punching of the perforation itself, can be arranged around the perforation. However, it can also be formed by inserting a mandrel in the perforation after production thereof. A further option is that the material piece that is at least partially cut out during perforation is folded and turned over and the overlapping parts are placed on the adjacent material, thus resulting in an elevation of the second medium layer at this point. When the filter medium is folded together to form a filter bellows, media layers thus abutting do not touch one another in a planar manner, but are held at a distance by the overturned material pieces. In this way the filtered fluid can drain more easily due to the drainage effect of the channels that are thus formed, and a favorable influencing of the flow of filtered fluid is achieved.

In a favorable embodiment, the second medium layer can have a structure that is perpendicular to the throughflow direction with a thickness that is designed to vary perpendicularly to the throughflow direction. Owing to the structure, the surface of the second medium layer can be made uneven, so that abutting media layers in the filter bellows do not touch one another in a planar manner, but are held at a distance by the overturned material pieces. In this way the filtered fluid can drain more easily due to the drainage effect of the channels that are thus formed, and a favorable flow influence of the filtered fluid is therefore achieved. The structure can preferably be arranged downstream on the second medium layer.

Advantageously, the second medium layer can be designed as a support layer with a mechanical strength that is suitable for supporting the first medium layer in an intended function against the fluid that is flowing through. In this way, for example, a poorly form-stable fiber layer used as the first medium layer is stiffened by the second medium layer so that the filter medium remains stable even when the flow pressure of the filtered fluid increases.

In an advantageous embodiment, the structure of the second medium layer can form channels perpendicular to the throughflow direction of the fluid which effect drainage of the filtered fluid. These channels bring about a drainage effect, as a result of which the filtered fluid can drain or can be distributed in the filter bellows and thus the overall flow resistance of the filter element is reduced.

Expediently, the first medium layer can have fibers. Fiber layers are commonly used and are very effective filter media, which can reliably filter out particles and oil. In addition, using such fiber layers, the desired mesh widths of the filter medium can be set with precision. The fiber layer can comprise glass fibers, but also, for example, synthetic PET-based fibers.

In a further favorable embodiment, at least one third medium layer can also be arranged downstream after the second medium layer. Such a further medium layer can be arranged, for example, for the additional filtration of smaller particles which have also passed through the first medium layer. In this manner, the overall degree of filtration can be further increased.

According to a further aspect, the invention relates to a filter element that comprises a filter medium according to the above description with a first medium layer for filtering a fluid and a second medium layer as a support and drainage layer for the first medium layer. Here the filter medium is folded, in particular folded in a star or round shape. The filter medium according to the invention has a combination of such a support and drainage layer as a second medium layer downstream of the first medium layer, which, for example, can filter fibers of the first medium layer from the filtered fluid and retain them. At the same time, this support and drainage layer can be designed as an open-pored filter medium or also with a perforation and/or additional structure, in order to intensify the drainage effect. The structure of the second medium layer can be applied by the production process of the filter medium (deposition) or subsequently by molding (pleating) or pressing or also in a perforation step. Cut off (separated) regions can be applied in an overlapping manner on other regions, so that a structure is produced. In a design without perforations, that is, here as a closed second medium layer, the use as a support and drainage layer and retention layer for fiber media is favorable and suitable.

According to a further aspect, the invention relates to a filter system that comprises a filter element, wherein the filter element has a filter medium with a first medium layer for filtering a fluid and a second medium layer as a support and drainage layer for the first medium layer, wherein the filter medium is folded, in particular in a star or round shape.

According to a further aspect, the invention relates to a method for producing a filter medium as described above, with the steps (i) of bonding a first medium layer to a second medium layer, wherein the second medium layer is formed by application of a planar layer on the first medium layer, and (ii) production of a structure that is independent of a structure of the first medium layer in the second medium layer.

The two media layers are expediently connected so that the filter medium can be processed in a single piece, for example by folding of the filter medium, in order to produce a filter bellows and a filter element in further manufacturing steps. Here, the second medium layer, which consists of cellulose, for example, can be directly applied to the first medium layer, for example a fiber layer, as a result of which the two medium layers are securely bonded to one another. Alternatively, it is also conceivable to directly apply the first medium layer, for example a fiber layer, to a finished second medium layer, for example a cellulose layer. It is optionally conceivable that the second medium layer is in only loose contact with the first medium layer. Despite this, for example in the case of a filter bellows folded in a star shape, the second medium layer is fixed adequately securely in the filter element by suitable shaping of the filter element.

The second medium layer can expediently receive its structure before bonding with the first medium layer.

Advantageously, in the method for producing a filter element, the structure of the second medium layer can be formed by stamping or rolling. By stamping and/or rolling of the second medium layer, which can be made of cellulose for example, indentations such as pleated channels or indentations in the form of circles or similar geometric structures can be stamped or rolled directly into the material, which can be done very economically.

In the method for producing the filter medium, it can also be expedient to form the structure of the second medium layer by cutting and/or punching. These methods are preferably used when perforations have to be made in the second medium layer. Here, material pieces are at least partially cut out or punched, and then the cut-out pieces of material are turned over and the overlapping parts are placed on the second medium layer, so that when the different medium layers are placed against one another, they are held at a distance from one another by the overturned material pieces and thus drainage structures such as channels are formed.

Advantageously, in the method for producing a filter medium, the structure of the second medium layer can be formed by pleating and/or pressing. For example, already pleated cellulose layers can also be provided with structures such as circles or similar geometric patterns, which on the one hand can serve to stiffen the second medium layer, and on the other hand there can also be an additional drainage effect to the channels formed by the pleating. Alternatively, however, media layers that are only pleated or pressed can also be used.

In an advantageous embodiment, the method for producing a filter medium can comprise at least one of the steps: application of a spray adhesive layer on the first and/or the second medium layer; lamination of the filter medium; calendering of the filter medium, as well as subsequent folding of the filter medium. In this embodiment, the two media layers can be glued, which constitutes an especially stable and long-lasting bond of the two medium layers. Toward this end, for example at least one of the two media layers can be sprayed with a spray adhesive and then laminated. Further, the filter medium can be calendered in order to achieve a uniform thickness of the finished filter medium. For numerous applications, it is further advantageous if the filter medium is folded loosely, for example in the form of a folded star or circle, so that a greatest possible surface area can be accommodated in a compact installation space.

According to a further aspect, the invention relates to the use of such a filter element as an oil or fuel filter, in particular as an oil or fuel filter for an internal combustion engine.

### BRIEF DESCRIPTION OF DRAWINGS

Further advantages arise from the following drawing description. Exemplary embodiments of the invention are provided in the drawings. The drawings, the description, and the claims contain numerous features in combination.

Expediently, the person skilled in the art will also consider the features separately and combine them to form further meaningful combinations.

For example:

FIG. 1 shows a section through a schematically represented filter medium with a first and a second medium layer with a structure according to an exemplary embodiment of the invention, wherein the second medium layer is structured only at its free surface;

FIG. 2 shows a section through a schematically represented filter medium with a first and a second medium layer according to a further exemplary embodiment of the invention, wherein the second medium layer has a pleated design;

FIG. 3 shows a plan view of a second medium layer of a filter medium with a structure according to an exemplary embodiment of the invention;

FIG. 4 shows a section through the filter medium with a second medium layer with a structure as shown in FIG. 3;

FIG. 5 shows a plan view of a filter medium with a second medium layer with perforations in accordance with one further exemplary embodiment of the invention;

FIG. 6 shows a section through the filter medium with a second medium layer with perforations as shown in FIG. 5;

FIG. 7 shows a plan view of a filter medium with a second medium layer with perforations and overlapping parts according to a further exemplary embodiment of the invention;

FIG. 8 shows a section through two parts, one atop the other, of a filter medium with a second medium layer with perforations and overlapping parts as shown in FIG. 7;

FIG. 9 shows a section through a filter medium with a second medium layer with a structure and an additional third medium layer according to a further exemplary embodiment of the invention;

FIG. 10 shows a filter element with a pleated filter medium according to a further exemplary embodiment of the invention; and

FIG. 11 shows a filter system according to a further exemplary embodiment of the invention.

### DETAILED DESCRIPTION OF PREFERRED EMBODIMENTS

In the figures, identical or similar components are numbered with the same references. The figures show only examples and are not to be understood as limiting.

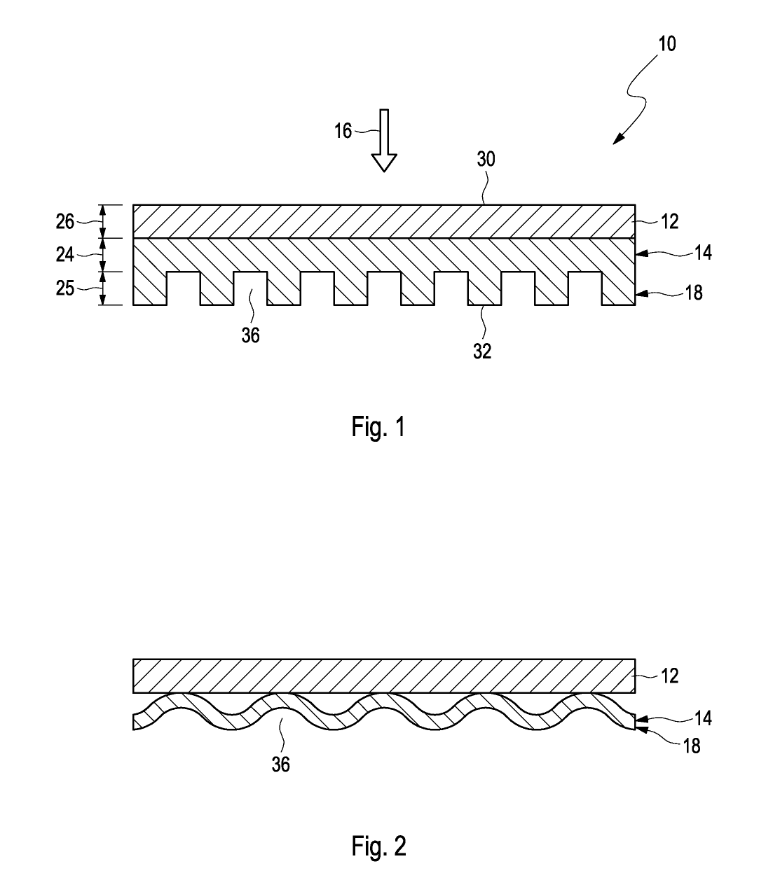

FIG. 1 shows a section through a schematically represented filter medium 10 with a first medium layer 12 and a second medium layer 14 with a structure 18 according to an exemplary embodiment of the invention. The filter medium 10 is intended for the filtration of a fluid in an intended throughflow direction 16 from an inlet side 30 to an outlet side 32 and comprises a first medium layer 12 and a second, planar medium layer 14 which covers the first medium layer as a support and drainage layer. Here the second medium layer 14 is arranged downstream of the first medium layer 12 in the throughflow direction 16. The retention capacity of the second medium layer 14 as a whole with respect to particles in the fluid which passes through the first medium layer 16 is less than the retention capacity in the first medium layer 12. The second medium layer 14 has a structure 18 with thickness 25 that is designed to vary perpendicularly to the throughflow direction 16. Here, the structure 18 is arranged downstream of the second medium layer 14. Basically, however, it is also conceivable that the structure 18 is arranged on the inlet side.

The first medium layer 12 has fibers for filtering out particles from the fluid, for example oil of an internal combustion engine. The second medium layer 14 is configured as a support layer with a mechanical strength that is suitable for supporting the first medium layer 12 in an intended function against the fluid that is flowing through. The second medium layer 14 has a planar medium, preferably cellulose. However it can also comprise a plastic film. Alternatively, the plastic film can be used with a fiber medium as a second medium layer 14. Here the plastic film can serve to stiffen the fiber medium and in addition intensify the drainage effect. The structure 18 of the second medium layer 14 forms channels 36 running perpendicular to the throughflow direction 16 of the fluid, which effect a drainage of the filtered fluid.

The first medium layer 12 is connected to the second medium layer 14, wherein the second medium layer 14 can be formed by application of a fiber layer on the first medium layer 12. The structure 18 of the second medium layer 14 can, for example, be formed by stamping and/or rolling. Alternatively, it is also conceivable to form the structure 18 of the second medium layer 14 by pleating and/or pressing. In addition, already pleated medium layers 14 can additionally be pressed in order to achieve a desired structure.

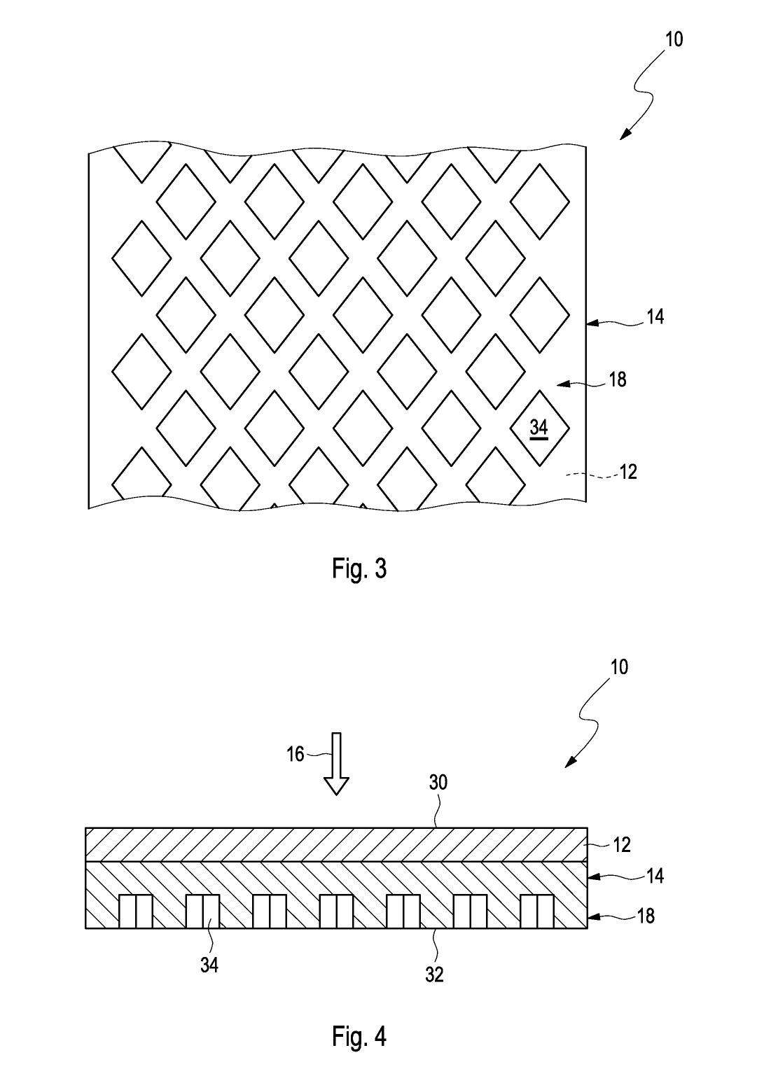

In this regard, FIG. 2 shows a schematic section through a filter medium 10 with a second medium layer 14 in a pleated design according to a further exemplary embodiment.

FIG. 3 shows a plan view of a second medium layer 14 of a filter medium 10, wherein the second medium layer 14 is provided with the structure 18 according to an exemplary embodiment of the invention. Here, the structure 18 is represented by bead-like indentations 34 in the second medium layer 14. These can be produced by rolling of the second medium layer 14 or stamping/pressing. In the plan view of FIG. 3, the first medium layer 12 produced lies behind the second medium layer 14 and is therefore not visible.

In addition, a section through the filter medium 10 with the second medium layer 14 with structure 18 as shown in FIG. 3 is shown in FIG. 4. The structure 18 is formed by indentations 34 between elevations and is situated on the side of the second medium layer 14 facing away from the flow direction 16, thus downstream of the filter medium 10. Here, both medium layers 12, 14 can be securely bonded, for example glued, to one another.

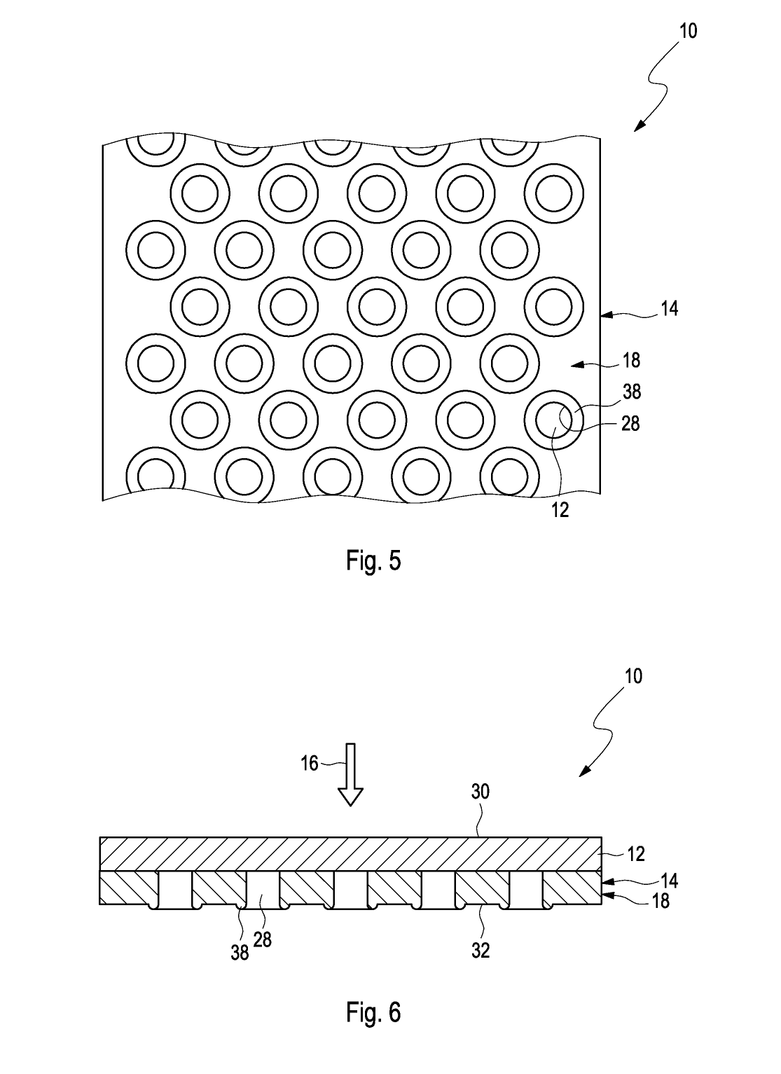

FIG. 5 shows a plan view of a second medium layer 14 of a filter medium 10, wherein the second medium layer 14 has perforations 28 in the throughflow direction 16, according to a further exemplary embodiment of the invention. Here, the structure 18 of the second medium layer 14 in the form of perforations 28 can be formed by cutting and/or punching. Any optional forms of perforation 28 are conceivable. In FIG. 5, circles are shown by way of example. However triangular, rectangular, or similar geometrically shaped perforations 28 can be punched out or cut out. In the plan view of FIG. 5, the first medium layer 12 lies behind the second medium layer 14 and can be seen only through the perforations 28.

In addition, a section through the filter medium 10 with a second medium layer 14 with perforations 28 as shown in FIG. 5 is shown in FIG. 6. These perforations 28 accordingly represent through openings in the material of the second medium layer 14. After passing through the first medium layer 12, the fluid can therefore pass directly through the second medium layer 14 at the position of these perforations 28. It is further apparent in the section that the perforations 28 can be encompassed by elevations 38 of the material of the second medium layer 14. The elevations 38 typically arise from punching of the material and in this case can be favorably used as spacers when filter media are laid atop one another or folded. The elevations 38 can however also be formed by inserting a mandrel in the perforations 28.

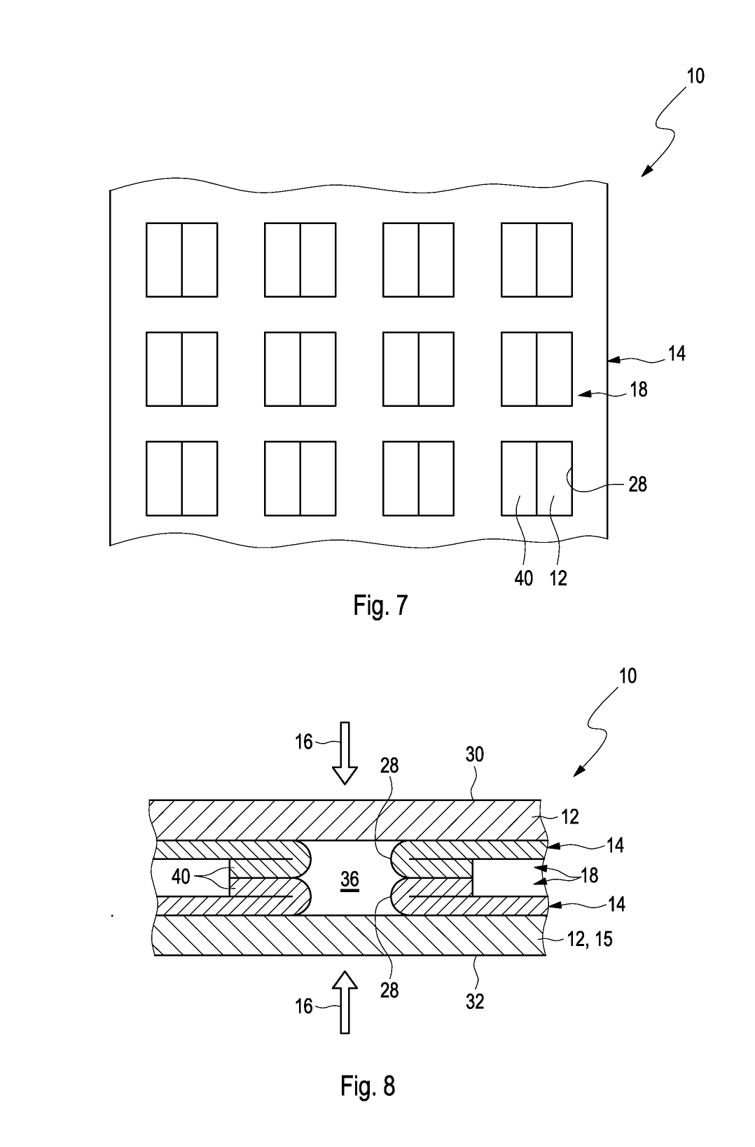

FIG. 7 shows a plan view of a filter medium 10 with a second medium layer 14 with perforations 28 and overlapping parts 40 according to a further exemplary embodiment of the invention. Here, the perforations 28 are punched out in a rectangular shape on three sides, for example, so that the punched-out material remains connected to the second medium layer 14 and can subsequently be opened out and folded back on the second medium layer 14 as an overlapping part 40. The overlapping parts 40 can lie freely on the second medium layer 14, but they can also be fixed to it by an adhesive layer in order to maintain a secure position and stability in the long term.

In addition, a section through two parts of the filter medium 10, one atop the other, with a second medium layer 14 with perforations 28 and overlapping parts 40 as shown in FIG. 7 is shown in FIG. 8. The two filter media, which respectively comprise a first medium layer 12 and a second medium layer 14 with perforations 28 and associated overlapping parts 40, together with the second medium layer 14 are placed against one another or folded so that, due to the perforations 28 atop one another, channels 36 which have a favorable flow influence on the fluid owing to a drainage effect can also be produced when said perforations are made longitudinally in a direction perpendicular to the drawing plane.

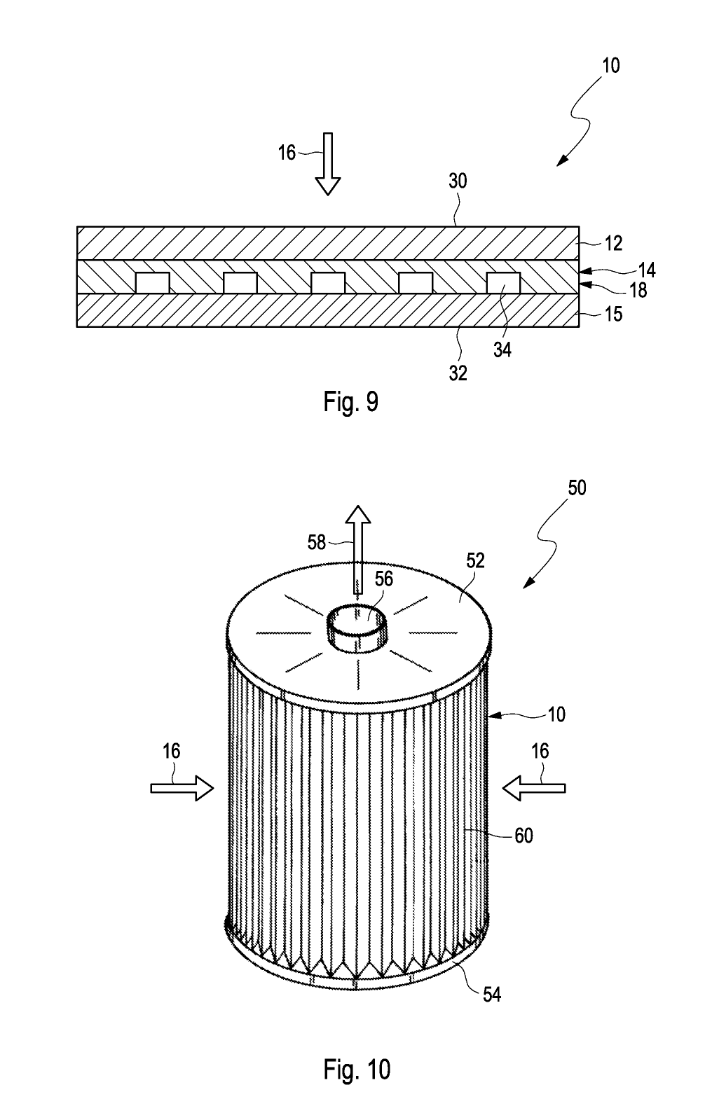

FIG. 9 further shows a section through a filter medium 10 with a second medium layer 14 with structure 18 and an additional third medium layer 15 according to a further exemplary embodiment of the invention. Here, the third medium layer 15 is arranged downstream on the structure 18, which is formed by the second medium layer 14. A third medium layer 15 can, for example, prove favorable for filtration of the fluid to remove further particles that cannot be filtered out by the first medium layer 12.

FIG. 10 shows a filter element 50 with a pleated filter medium 10 according to a further exemplary embodiment of the invention. The filter element 50 comprises a filter medium 10 as described above, with a first medium layer 12 for filtering a fluid and a second medium layer 14 as a support and drainage layer for the first medium layer 12, wherein the filter medium 10 is folded, in particular in a star or round shape. The filter medium can be produced according to one or more of the steps: application of a spray adhesive layer on the first and/or the second medium layer 12, 14; lamination of the filter medium 10; calendering of the filter medium 10; and folding of the filter medium 10. By folding the filter medium 10, the effective surface area of the filter medium 10 available for filtration can be increased.

The filter element 50 comprises a filter bellows made from the pleated filter medium 10, which is folded endlessly in a circular shape and is closed at both faces by means of the end disks 52 and 54. Here, the fold edges 60 terminate in a cylindrical form with the end disks 52, 54 at the outer circumference. At the same time, the throughflow direction 16 of the fluid runs radially from the outside to the inside, so that the filtered fluid can leave the filter element 50 once more through the outlet 56 in the axial outflow direction 58.

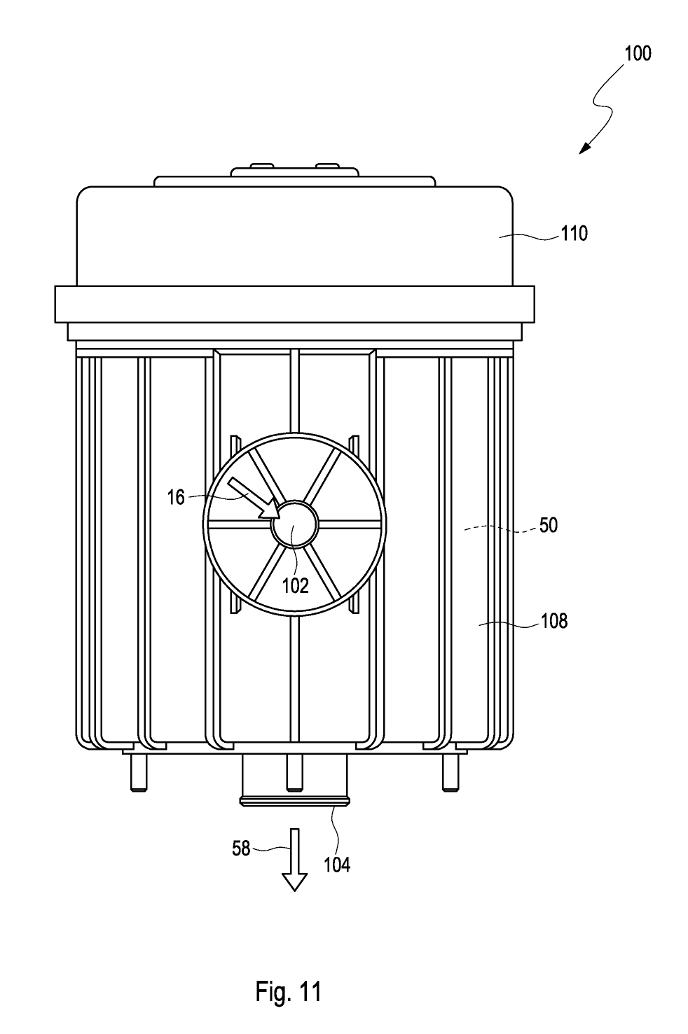

FIG. 11 shows a filter system 100 according to a further exemplary embodiment of the invention, which comprises a filter housing 108, which is closed by means of a cover 110, which, for example, can be configured to be screwed or clipped. The filter housing 108 has a radial inlet 102, through which the fluid can enter in a throughflow direction 16 and pass radially through the filter bellows of a filter element 50 arranged in the interior of the filter housing 108 and therefore not visible in FIG. 11. Further, the filter housing has an axial outlet 104 into which the outlet 56 of the filter element 50 opens out, and through which the filtered fluid can exit again in the outflow direction 58.

1. A filter medium for the filtration of a fluid in an intended throughflow direction from an inlet side of the filter medium to an outlet side, the filter medium comprising:
at least one first medium layer for filtering a fluid;
and at least one second planar medium layer as a support and drainage layer for the first filter medium layer;
wherein the second medium layer is arranged downstream of the first medium layer in the throughflow direction;
wherein a retention capacity of the second medium layer as a whole with respect to particles in the fluid that passes through the first medium layer is less than the retention capacity in the first medium layer.

2. The filter medium according to claim 1, wherein
the second medium layer comprises one of: a fiber filter medium or a cellulose fiber medium.

3. The filter medium according to claim 1, wherein
the second medium layer comprises a plastic film.

4. The filter medium according to claim 1, wherein
the second medium layer has perforations in the throughflow direction.

5. The filter medium according to claim 1, wherein
the second medium layer has a structure perpendicular to the throughflow direction with a thickness that is designed to vary perpendicularly to the throughflow direction.

6. The filter medium according to claim 1, wherein
the second medium layer is a support layer having a mechanical strength that is suitable for supporting the first medium layer in an intended function against the forces induced by fluid that is flowing through.

7. The filter medium according to claim 5, wherein
the structure of the second medium layer forms channels arranged perpendicular to the throughflow direction of the fluid which effect drainage of the filtered fluid.

8. The filter medium according to claim 1, wherein
the first medium layer is a fibrous layer.

9. The filter medium according to claim 1, further comprising:
at least one third medium layer arranged downstream after the second medium layer.

10. A filter element comprising a filter medium, the filter medium for the filtration of a fluid in an intended throughflow direction from an inlet side of the filter medium to to an outlet side, the filter medium comprising:
at least one first medium layer for filtering a fluid; and
at least one second planar medium layer as a support and drainage layer for the first filter medium layer;
wherein the second medium layer is arranged downstream of the first medium layer in the throughflow direction;
wherein a retention capacity of the second medium layer as a whole with respect to particles in the fluid that passes through the first medium layer is less than the retention capacity in the first medium layer;
wherein the filter medium is folded forming start shaped pleats or folded to form a round filter element.

11. A filter system comprising:
a filter element comprising a filter medium, the filter medium for the filtration of a fluid in an intended throughflow direction from an inlet side of the filter medium to to an outlet side, the filter medium comprising:
at least one first medium layer for filtering a fluid; and
at least one second planar medium layer as a support and drainage layer for the first filter medium layer;
wherein the second medium layer is arranged downstream of the first medium layer in the throughflow direction;
wherein a retention capacity of the second medium layer as a whole with respect to particles in the fluid that passes through the first medium layer is less than the retention capacity in the first medium layer;
wherein the filter medium is folded forimg start shaped pleats or folded to form a round filter element;
wherein the filter element has a filter medium with a first medium layer for filtering a fluid and a second medium layer as a support and drainage layer for the first medium layer;
wherein the filter medium is folded forming start shaped pleats or folded to form a round filter element.

12. A method for producing a filter medium for the filtration of a fluid in an intended throughflow direction from an inlet side of the filter medium to to an outlet side,
the filter medium comprising:
at least one first medium layer for filtering a fluid;
and at least one second planar medium layer as a support and drainage layer for the first filter medium layer;
wherein the second medium layer is arranged downstream of the first medium layer in the throughflow direction;
wherein a retention capacity of the second medium layer as a whole with respect to particles in the fluid that passes through the first medium layer is less than the retention capacity in the first medium layer.
wherein the method of producing a filter medium comprises the steps of:
bonding of a first medium layer to a second medium layer;
wherein the second medium layer is formed by application of a planar layer on the first medium layer; and
production of a structure that is independent of a structure of the first medium layer in the second medium layer.

13. The method for producing a filter medium according to claim 11, wherein
in the production step, the structure of the second medium layer is formed by stamping and/or rolling.

14. The method for producing a filter medium according to claim 11, wherein
in the production step, the structure of the second medium layer is formed by cutting and/or punching.

15. The method for producing the filter medium according to claim 11, wherein
in the production step, the structure of the second medium layer is formed by pleating and/or pressing.

16. The method for producing a filter medium according to claim 11, further comprising at least one of the steps:
applying a spray adhesive layer onto the first and/or the second medium layer;
laminating the filter medium layers together;
calendering the filter medium layers together;
folding the filter medium.
